(19) United States
(12) Patent Application Publication
(10) Pub. No.: US 2014/0017030 A1
(43) Pub. Date: Jan. 16, 2014

(54) LOCKING SCREW APPARATUS AND METHODS THEREOF

(71) Applicant: JOHN DEALTO, Brick, NJ (US)

(72) Inventor: JOHN DEALTO, Brick, NJ (US)

(21) Appl. No.: 13/933,117

(22) Filed: Jul. 1, 2013

Related U.S. Application Data
(60) Provisional application No. 61/666,774, filed on Jun. 29, 2012.

(51) Int. Cl. F16B 39/28

(52) U.S. Cl. CPC F16B 39/28
USPC 411/168; 411/166

(57) ABSTRACT

A locking screw apparatus is provided. In exemplary embodiments, the locking screw apparatus may comprise, a stem; a head attached to the stem; a threaded portion adjacent the stem, the threaded portion having a set of screw threads disposed thereon; and a locking means comprising a protrusion adapted to resist counter-rotation of the locking screw apparatus once in place within a material, the protrusion comprising at least one of counter-angled threads and one or more locking teeth.

### CROSS-REFERENCE TO RELATED APPLICATIONS

The present application claims priority to U.S. Provisional Patent Application Ser. No. 61/666,774 entitled “Locking Screw Apparatus and Methods Thereof,” filed Jun. 29, 2012, the disclosure of which is incorporated herein by reference in its entirety.

### BACKGROUND

1. Field of the Invention

Embodiments of the present invention are generally related to a locking screw apparatus and methods thereof. More specifically, embodiments of the present invention relate to a mechanical fastener, such as a screw, having a first set of traditional screw threads and a set of locking threads or teeth.

2. Description of Related Art

Screws are conventionally used to join two members together. Screws generally include threaded portions to allow the screws to penetrate a substrate and join the substrate with a second structure. For example, a wood screw may be used to join two or more pieces of wood to form a structure. However, after screws have been installed, they may become loose and/or disengage a substrate when subjected to counter-rotation. When screws become loose and/or disengage from a substrate and/or other materials, the joined substrates and/or materials may become detached. In the case of structure installed in a home, loose screws may become an injury hazard. For example, if one or more screws in a wooden step of a deck become loose, the step may become unstable, and may cause injury to a person using the step. A loose screw itself may also become a hazard. For example, a loose screw may protrude from a substrate, and cause injury to a user that steps on or otherwise comes into contact with the loose screw.

Thus, there is a need for a locking screw apparatus adapted to prevent counter rotation and/or loosening of the screw.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a front view of locking screw apparatuses in accordance with embodiments of the present invention;

FIG. 2 depicts a side view of a locking screw apparatus embedded within a wall material in accordance with one embodiment of the present invention; and

FIG. 3 depicts a flowchart of a method of using a locking screw apparatus in accordance with another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the Figures.

### SUMMARY

Embodiments of the present disclosure generally relate to a locking screw apparatus In one embodiment, a locking screw apparatus may comprise a stem; a head attached to the stem; a threaded portion adjacent the stem, the threaded portion having a set of screw threads disposed thereon; a locking means comprising a protrusion adapted to resist counter-rotation of the locking screw apparatus once in place within a material, the protrusion comprising at least one of counter-angled threads and one or more locking teeth.

In another embodiment of the present disclosure, a locking screw apparatus may comprise a head; a threaded portion attached to the head; a set of crew threads disposed on a distal portion of the threaded portion opposite the head; a locking means comprising counter-angled threads adapted to resist counter-rotation of the locking screw apparatus once in place within a material, the locking means disposed on a proximal portion of the threaded portion adjacent the head.

In yet another embodiment of the present disclosure, a method of using a locking screw apparatus may comprise providing materials to screw together; providing a locking crew apparatus comprising: a stem; a head attached to the stem; a threaded portion adjacent the stem, the threaded portion having a set of screw threads disposed thereon; a locking means comprising a structural protrusion adapted to resist counter-rotation of the locking screw apparatus once in place within a material, the structural protrusion comprising at least one of counter-angled threads and one or more locking teeth; rotating the locking screw apparatus in a first direction until the locking screw apparatus is fully recessed within the materials; and counter-rotating the screw in a second direction, thereby enabling the locking means to engage the materials and resist counter-rotation.

### DETAILED DESCRIPTION

Embodiments of the present invention are generally related to a locking screw apparatus and methods thereof. More specifically, embodiments of the present invention relate to a mechanical fastener, such as a screw, having a first set of traditional screw threads and a set of locking threads or teeth.

Although embodiments of the present invention are described as being dedicated to screws, those of ordinary skill in the art may recognize equally suitable uses for embodiments of the present invention for any type of mechanical fastener. As such, the systems and methods described herein should not be limited to the intended uses disclosed herein, but should be inclusive of alternative uses provided the novel features of embodiments of the present invention remain.

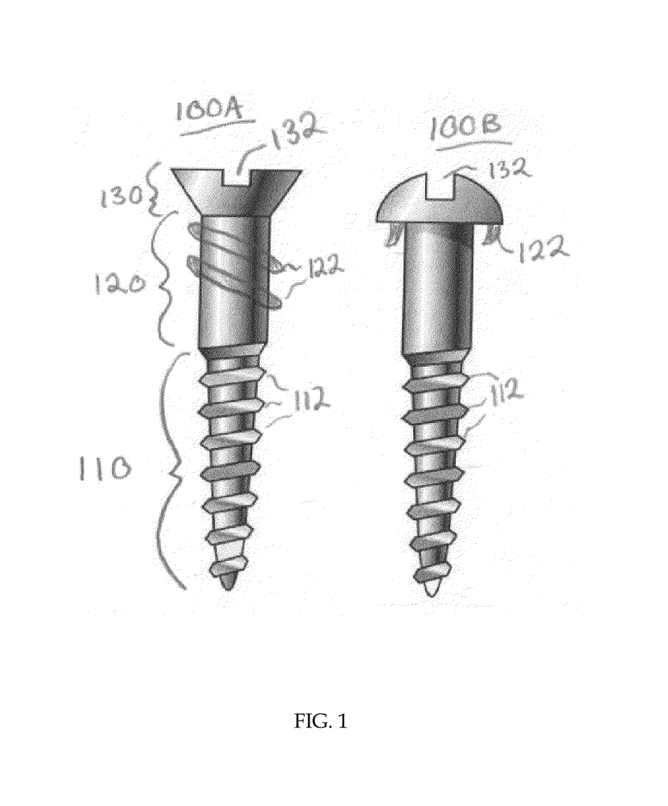

FIG. 1 depicts a front view of locking screw apparatuses in accordance with embodiments of the present invention. As shown in the Figure, two locking screw apparatuses 100A and 100B are presented. The first locking screw apparatus 100A generally comprises a threaded portion 110 having a plurality of screw threads 112 thereon, a stem 120 having a plurality of locking threads thereon, and a head 130 having a recess 132 therein. The second locking screw apparatus 100B is similarly designed, however, rather than having a plurality of locking threads, a set of locking teeth 122 are provided. In addition, the head design thereof is a different style. However, it should appreciated, as explained further herein, such design variations are well within the scope of various embodiments of the present invention.

The locking screw apparatus 100 of embodiments of the present invention may comprise any type or design of screw apparatus suitable for embodiments of the present invention. For example, in various embodiments the locking screw apparatus 100 may comprise a: chipboard screw, particle board screw, concrete screw, masonry screw, confast screw, blue screw, self-tapping screw, deck screw, double ended screw, dowel screw, drywall screw, eye screw, lag screw, mirror screw, security screw, sheet metal screw, twinfast screw, wood screw, cap screw, hex cap screw, machine screw, self-drilling screw, Teks screw, set screw, shoulder screw, thread rolling screw, or the like.

The head 130 of the locking screw apparatus 100 may comprise any type of suitable head design known in the industry. The head 130 may comprise a head 130 and recess 132 design such as an external head design (e.g., square, hex, pentagon, thumbscrew, or the like), slotted head design (e.g., slot, cross, or the like), cruciform head design (e.g., Phillips, Frearson, French recess, JIS B 1012, Mortorq, Pozidriv, Supradriv, Robertson, hex socket, hexalobular socket, TTAP, or the like), tamper-resistant head design (e.g., breakaway head, Bristol, clutch, claw, double hex, line, one-way, pentalobe, polydrive, spanner, spline, Torq-set, TA, TP3, tri-wing, triple square, protruding obstacle or the like), or variations thereof.

The threaded portion 110 and screw threads 112 may comprise any type of design suitable for embodiments of the present invention. For example, the screw threads may comprise any standard screw threads as established by any industry recognized standardization organization. As such, embodiments of the present invention may comply with ISO, UTS, or the like.

The locking threads or teeth 122 utilized in embodiments of the present invention enable embodiments of the present invention to effectively lock in place as described herein. Such locking threads and/or teeth (collectively “locking means”) 122 may comprise any structural protrusion capable of increasing the resistivity to counter-rotation of the locking screw apparatus once in place within a material. As shown in the locking screw apparatus 100A, the locking threads 122 may comprise counter-angled threads, such that once the screw is inserted in a wall or material via the threads 112, the locking threads 122 could engage an internal material to the wall upon a slight counter-rotation of the locking screw apparatus. Similarly, as shown in the locking screw apparatus 100B, the locking teeth 122 may be counter-pitched such that once the locking screw apparatus is inserted in a wall via the threads 112, upon a slight counter-rotation of the locking screw apparatus, the locking teeth 122 may engage an internal (or depending on the positioning of the locking teeth, an external) portion of the wall. The locking means 122 may be integral with the screw apparatus 100A, 100B, or may be detachably attachable. The locking means 122 may comprise a separate apparatus adapted to couple with any screw. By way of example, the locking means 122 may comprise a spate apparatus adapted to couple with a screw with a smooth shank. In some embodiments, the locking means 122 may comprise spikes or jagged portions. In some embodiments, the locking means 122 may be retractable. In some embodiments, the locking means 122 may be coupled with a button or actuator coupled with the locking means 122. For example, a mechanical button may be disposed on the head of the screw for activating and/or deactivating the locking means 122.

In additional embodiments, the locking means 122 may be bendable, flexible, or rotatable about a single point, such that they do not substantially interfere when the locking screw apparatus is inserted into a wall or board. However, once a counter-rotation is made (as described hereinbelow), the locking means 122 may be adapted to extend to its full length and the locking means 122 may operate as intended. Although depicted as being disposed on a proximal end and/or the shank of a screw 100A, 100B, the locking means 122 may be disposed on the distal end of the screw or in the center of the screw, or the like. Although the locking teeth 122 are depicted as being disposed under the head of a screw 122, locking teeth 122 may be disposed anywhere on the screw.

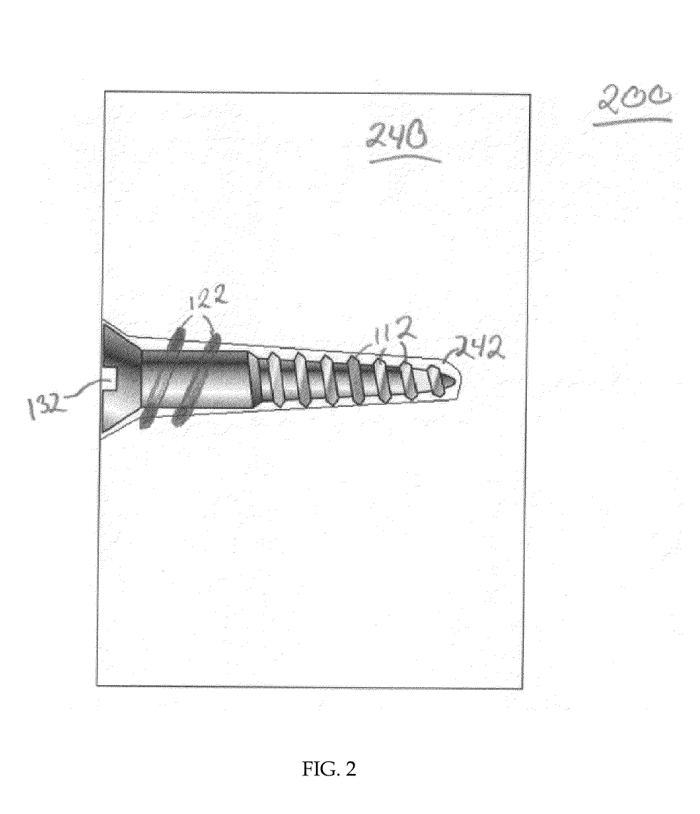

FIG. 2 depicts a side view of a locking screw apparatus embedded within a wall material in accordance with one embodiment of the present invention. As shown in the Figure, the locking screw apparatus and wall assembly 200 generally comprises a locking screw apparatus as described herein, embedded and substantially secured within a channel 242 formed within a wall 240. Although a wall 240 is shown, the wall 240 may also comprise a board, drywall, timbers, etc., without departing from the scope of embodiments of the present invention.

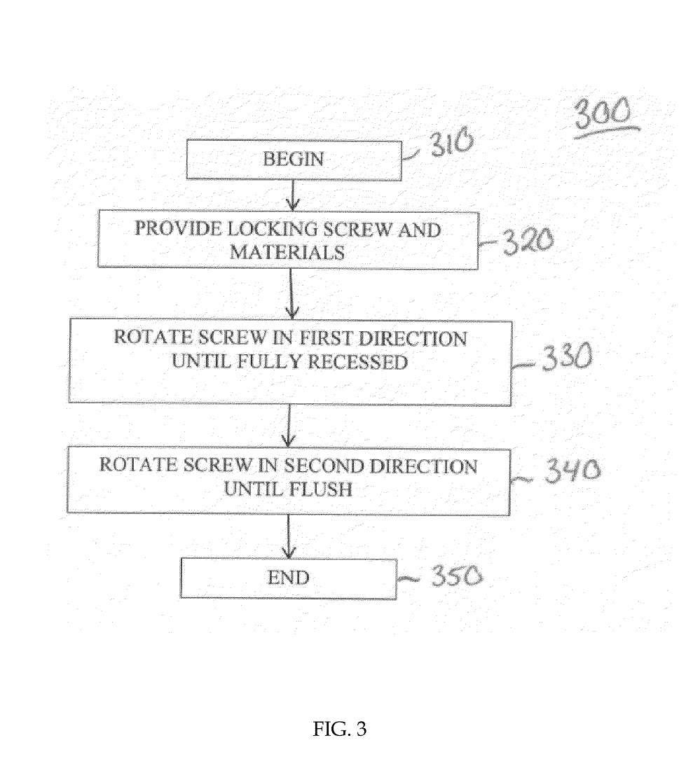

To appreciate the general process for utilizing the locking screw apparatus within the wall, reference shall be made to FIG. 3, which depicts a flowchart of a method of using a locking screw apparatus in accordance with another embodiment of the present invention. The method 300 begins at step 310.

At step 320, an individual is provided with a locking screw apparatus 100 and materials to screw together. In many embodiments the materials to screw together comprise a sheet of drywall and a board within a wall structure. However, embodiments of the present invention should not be limited to any particular combination of materials to be fastened via the locking screw assembly. The locking screw assembly generally comprises a threaded portion having a plurality of screw threads thereon, a stem having a plurality of locking threads thereon, and a head having a recess therein.

At step 330, the individual will rotate the locking screw assembly in a first direction (as dictated by the threads) until the locking screw assembly is fully recessed within the materials. For example, the locking screw assembly may be rotated until the top of the head of the locking screw assembly is slightly embedded within the materials. While such concept of being fully recessed may be beneficial in a majority of applications, it may not be necessary in certain embodiments. In the latter applications, the locking screw assembly should be rotated and embedded within the materials as needed to achieve the desired results.

At step 340, the individual will counter-rotate the screw (in a second direction), which would traditionally remove the screw from the materials. However, in embodiments of the present invention, such counter-rotation enables the locking means to engage the materials and prevent or resist such counter-rotation. As such, the locking screw apparatus is effectively locked in place. In many embodiments, the counter-rotation may be completed until the top of the head of the locking screw apparatus is flush with the outer surface of the material, to provide a clean smooth appearance.

The method 300 ends at step 350.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein.

What is claimed is:

1. A locking screw apparatus comprising:
a stem;
a head attached to the stem;
a threaded portion adjacent the stem, the threaded portion having a set of screw threads disposed thereon; and
a locking means comprising a protrusion adapted to resist counter-rotation of the locking screw apparatus once in place within a material, the protrusion comprising at least one of counter-angled threads and one or more locking teeth.

2. The locking screw apparatus of claim 1, wherein the counter-angled threads are adapted to engage an internal portion of the material when the screw apparatus is counter-rotated after being inserted into the material via the threaded portion.

3. The locking screw apparatus of claim 1, wherein the locking teeth are adapted to engage an internal portion of the material when the screw apparatus is counter-rotated after being inserted into the material via the threaded portion.

4. The locking screw apparatus of claim 1, wherein the locking means is disposed on the stem.

5. The locking screw apparatus of claim 1, wherein the locking means is disposed on the head.

6. The locking screw apparatus of claim 1, wherein the head comprises at least one of an external head design, a slotted head design, a cruciform head design, and a tamper-resistant head design.

7. The locking screw apparatus of claim 1, wherein the screw threads comply with at least one of International Organization for Standardization and the Unified Thread Standards.

8. The locking screw apparatus of claim 1, wherein the locking means is at least one of bendable, flexible, and rotatable about a point, thereby preventing interference when the locking screw apparatus is inserted into the material.

9. The locking screw apparatus of claim 8, wherein the locking means extends to its full length when the screw is counter-rotated, thereby resisting counter-rotation of the screw apparatus.

10. The locking screw apparatus of claim 1, wherein the screw comprises a wood screw design, a machine screw design, a thread cutting machine screw design, a sheet metal screw design, a self-drilling sheet metal screw design, a hex bolt design, a carriage bolt design, a lag bolt design, a socket screw design, a set screw design, an eye bolt design, an eye lag design, a j-bolt design, a u-bolt design, a shoulder bolt design, an elevator bolt design, a barrel nut design, a mating screw design, and a hanger bolt design.

11. A locking screw apparatus comprising:
a head;
a threaded portion attached to the head;
a set of crew threads disposed on a distal portion of the threaded portion opposite the head; and
a locking means comprising counter-angled threads adapted to resist counter-rotation of the locking screw apparatus once in place within a material, the locking means disposed on a proximal portion of the threaded portion adjacent the head.

12. The locking screw apparatus of claim 11, wherein the head comprises at least one of an external head design, a slotted head design, a cruciform head design, and a tamper-resistant head design.

13. The locking screw apparatus of claim 11, wherein the screw threads comply with at least one of International Organization for Standardization and the Unified Thread Standards.

14. The locking screw apparatus of claim 11, wherein the locking means is at least one of bendable, flexible, and rotatable about a point, thereby preventing interference when the locking screw apparatus is inserted into the material.

15. The locking screw apparatus of claim 14, wherein the locking means extends to its full length when the screw is counter-rotated, thereby preventing counter-rotation of the screw apparatus.

16. The locking screw apparatus of claim 1, wherein the screw comprises a wood screw design, a machine screw design, a thread cutting machine screw design, a sheet metal screw design, a self-drilling sheet metal screw design, a hex bolt design, a carriage bolt design, a lag bolt design, a socket screw design, a set screw design, an eye bolt design, an eye lag design, a j-bolt design, a u-bolt design, a shoulder bolt design, an elevator bolt design, a barrel nut design, a mating screw design, and a hanger bolt design.

17. A method of using a locking screw apparatus, the method comprising:
providing materials to screw together;
providing a locking crew apparatus comprising:
a stem;
a head attached to the stem;
a threaded portion adjacent the stem, the threaded portion having a set of screw threads disposed thereon; and
a locking means comprising a structural protrusion adapted to resist counter-rotation of the locking screw apparatus once in place within a material, the structural protrusion comprising at least one of counter-angled threads and one or more locking teeth;
rotating the locking screw apparatus in a first direction until the locking screw apparatus is fully recessed within the materials; and
counter-rotating the screw in a second direction, thereby enabling the locking means to engage the materials and resist counter-rotation.

18. The method of claim 17, wherein the materials to screw together comprise at least one of a sheet of drywall and a board within a wall structure.

19. The method of claim 17, wherein the locking crew apparatus is fully recessed within the materials when the top of the head of the locking screw apparatus is embedded within the materials.

20. The method of claim 17, wherein the counter rotation is completed when a top of the head is flush with an outer surface of the material.
